(19) United States
(12) Patent Application Publication
(10) Pub. No.: US 2004/0130498 A1
(43) Pub. Date: Jul. 8, 2004

(54) Device for exciting a centrally focused reflector antenna

(76) Inventor: Frank E. Woetzel, Berlin (DE)

Correspondence Address: FASSE PATENT ATTORNEYS, P.A., P.O. BOX 726, HAMPDEN, ME, 04444-0726, US

(21) Appl. No.: 10/475,543

(22) PCT Filed: Apr. 19, 2002
(86) PCT No.: PCT/DE02/01511

(30) Foreign Application Priority Data
Apr. 21, 2001 (DE) 201 07 294.7

(51) Int. Cl. H01Q 13/00

(52) U.S. Cl. 343/775; 343/786

(57) ABSTRACT

The invention relates to a arrangement for feeding a centrally focused reflector antenna, comprising a waveguide (1), a dielectric field transformer (2) arranged on said waveguide (1) and a mounting platform (3) for a series of modules (8) which is embodied on one end of the waveguide (1) The waveguide (1) is provided with a means for receiving the dielectric field transformer (2) which partially protrudes into the waveguide (1). In a preferred embodiment, a dielectric support (9) is provided in the vicinity of the dielectric field transformer (2). The middle of said support has a circular bore (12) whose diameter corresponds to the diameter of the dielectric fields transformer (2). One advantage of the invention is that the centrally focused reflector antennae can be excited in the focal point thereof in a field-optimum broadband manner. No mechanically displaced components are required as a result of the dielectric fields transformer. The inventive device can be produced in a cost-effective manner with high mechanical precision and little effort. It is characterized by high tolerance with respect to various environmental conditions such as temperature, humidity of the air and aggressive media.

The present invention relates to an arrangement for feeding a centrally focused reflector antenna.

The arrangement has particular application in the areas of communications technology in stationary, portable and mobile transceiver systems of high-frequency electromagnetic radiation sources, in particular of geostationary and orbiting satellite systems, in mobile ground and air sources as well as in point-to-point radio relay transmission or point-to-multipoint radio relay transmission of safety, radar and non-contacting sensor equipment.

Prior arrangements for feeding a centrally focused reflector antenna system have used either a corrugated horn or a flatly flared waveguide piece as a feed system located at the end of the waveguide.

The feed system is disposed at the focal point, the phase center, of the reflector antenna and is intended to illuminate it in an optimum manner. Of particular significance is a largely uniform illumination of the reflector at uniform phase occupancy.

Prior arrangements for the purpose of feeding a reflector antenna system and its beam scanning have utilized a feed system at the focal point of the reflector antenna or a feed system mounted in the vicinity of the focal point, which consists of discrete radiating elements (ARRAY) or a combination of such an array fed by another system.

Due to the functionalities of the corrugated horn feed system or the flatly flared waveguide, known technical solutions for that purpose fail to achieve optimum field distribution in the reflector system and/or optimum illumination. Analogously, this also applies to feed systems designed to influence the antenna's radiation pattern, where especially in this case significant losses of gain and system quality occur or have to be accepted. This is equally true of suppressing undesired sidelobes.

As a result of design constraints, the necessary sealing of the waveguide system from environmental effects can be achieved only by using additional and expensive components which may possibly further degrade the functionality of the feed system. In addition, the prior feed systems cannot be combined with downstream modules, such as down converters, in a non-reactive manner. This means that in general additional work to provide for an optimum match between such a prior feed system and the downstream module, including the cost involved, will be required.

Therefore, it is an object of the present invention to provide a cost-effective arrangement for feeding centrally focused reflector antennas in a field-optimum broadband manner at their focal point, the phase center, while at the same time establishing a non-reactive connection to downstream modules and improving environmental sealing of the waveguide, and to ensure a proper match between the feed system and the respective reflector geometry (f/D ratio) so as to influence the design of the radiation pattern including the functionality of changing the field distribution at the waveguide end specifically with respect to the reflector system in such a way that no feedback into the waveguide and, therefore, into the downstream module will be caused.

In accordance with the invention, this objective is solved by an arrangement comprising the features of claim 1.

Preferred embodiments of the arrangement according to the invention are defined by the features of claims 2-11.

One particular advantage of the arrangement according to the invention is that it ensures that centrally focused reflector antennas will be fed in a field-optimum broadband manner at their focal points. No mechanically moved components are required as a result of the dielectric field transformer. The entire arrangement can be easily manufactured in a cost-effective manner with high mechanical precision, while it also exhibits high tolerance with respect to various environmental conditions such as temperature, air humidity and aggressive media.

In a preferred embodiment of the invention, mounting a dielectric support in the vicinity of the dielectric field transformer and mounting passive, easy-to-control radiator components on the dielectric support permits to change the broadband feed field of the field transformer while optimizing loss and field, without requiring mechanically displaced components and without having to mechanically connect the dielectric support to the field transformer.

Other advantages will become apparent from the following description of the arrangement according to the invention taken in conjunction with the accompanying drawings, wherein:

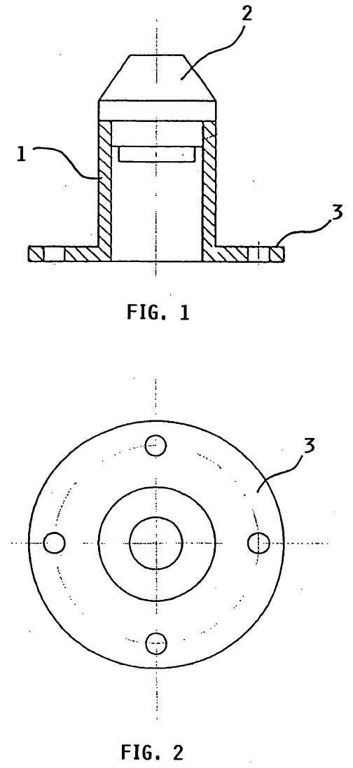

FIG. 1 shows a section of an arrangement according to the invention;

FIG. 2 is a plan view of the arrangement shown in FIG. 1;

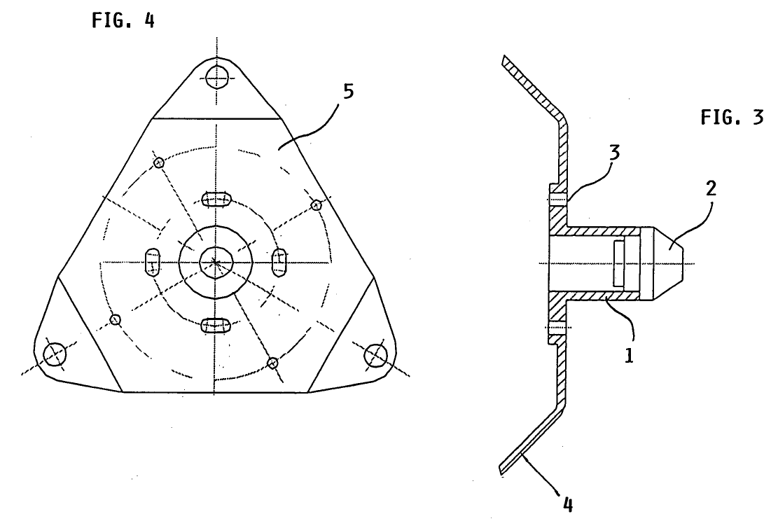

FIG. 3 shows a section of an arrangement according to the invention including a mount for mounting a circular reflector;

FIG. 4 is a rear view of the arrangement according to the invention shown in FIG. 3;

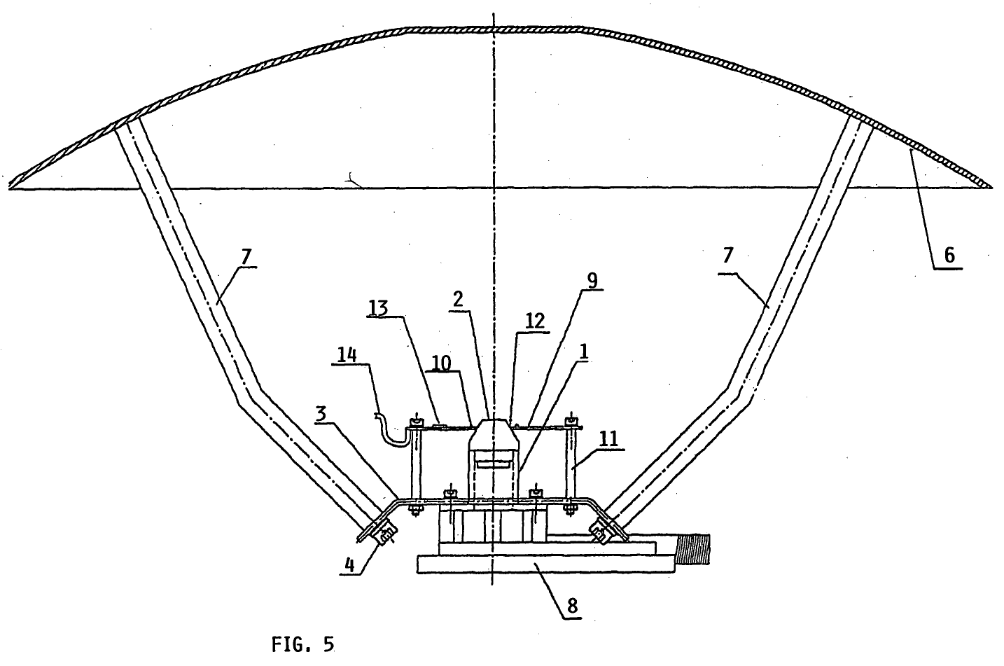

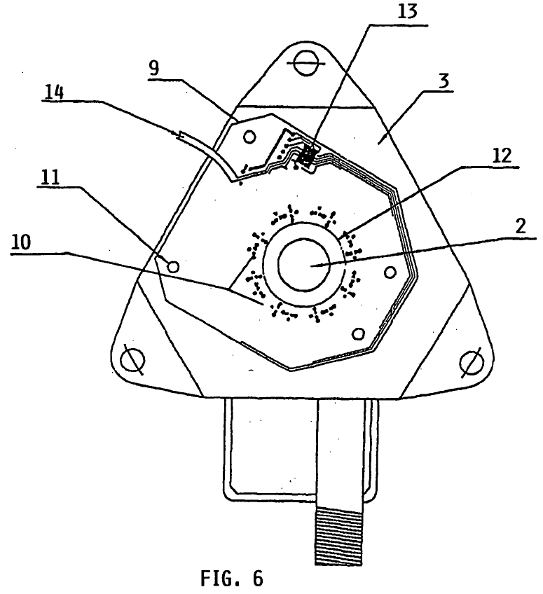

FIG. 5 shows a section of an arrangement according to the invention including the mounted reflector; and

FIG. 6 is a plan view of the dielectric support.

As shown in FIG. 1, the arrangement according to the invention comprises a blunt ended waveguide 1 closed on one side by a dielectric field transformer 2 which partly protrudes into the waveguide 2 and whose geometry corresponds, or is matched to, the reflector system used. At its other end, the waveguide 1 comprises a mounting platform 3 for downstream modules 8. The dielectric field transformer 2 affects the E components of the alternating electromagnetic field in the direction of propagation such that the original wave field will be deformed at the other end of the waveguide 1 so as to obtain a uniform, especially circular expansion of the resulting radiation field of the waveguide 1 and a selectable power distribution on the reflector. This causes a drastic increase in the efficiency of the arrangement as a whole.

In a preferred embodiment of the arrangement according to the invention, the downstream module 8 is not connected by any rigid mechanical means to the waveguide 1 and the mounting platform 3; instead, these are mounted in a rotatable and mechanically fixable manner about the axis of symmetry of the reflector 6. This provides the particular benefit that all functionalities of the system are maintained without changing the position of the entire antenna arrangement, particularly of the reflector 6, while any rotations of polarization with respect to the orthogonal alignment of the H/E vector to the normal earth plane—in this case especially the so-called skew angle—can be compensated for by rotating the downstream module 8.

Moreover, the dielectric field transformer 2 has the advantage that for a region of high bandwidth the influence on the field is nearly uniform, while at the same time a transformation from the waveguide wave mode to the free-space mode is realized, whereby the arrangement of dielectric field transformer 2/waveguide 1 can be connected to a downstream system without any feedback.

FIG. 3 depicts an arrangement according to the invention including the mount 4, shown folded here, for receiving a reflector, the dielectric field transformer 2 and the mounting platform 3 provided for downstream modules.

FIG. 4 is a rear view of this arrangement, in which the mounting platform 3 is formed as an equilateral triangle area 5 in order to minimize shadowing in the reflector.

In FIG. 5, the arrangement according to the invention is shown with a mounted reflector. The subreflector having a circular aperture 6 is mounted to the mounts 4 by means of the struts 7. In the present embodiment, the downstream modules 8 are bolted to the mounting platform 3. The arrangement according to the invention is positioned at the axis of rotation of the reflector 6 and with the dielectric field transformer 2 at the height of the focal point of the reflector 6.

As shown in FIG. 5, bolted spacers 11 are used to mount a support plate 9 in the vicinity of the dielectric field transformer 2. The dielectric support plate 9 includes a bore 12 at the location of the field transformer 2 having a diameter suitable for the field transformer 2, and is disposed in a plane-parallel fashion to the mounting platform 3 without having any direct mechanical or electrical connection to the dielectric field transformer 2.

The dielectric support plate 9, on which the passive radiator components and circuit elements 10 are mounted, has the effect that the source field from the dielectric field transformer 2 will only be slightly influenced depending on the openings in the dielectric support plate 9; as a consequence, the penetrating field and, therefore, the entire antenna arrangement will suffer only small attenuation so that an extremely high efficiency continues to be available. At the same time, the source field from the dielectric field transformer 2 can be influenced such that the resulting radiation pattern of the antenna may be varied within the limits desired for the application. Another benefit of this embodiment of the arrangement is that simple mechanical mounting means for different antenna layouts permit to achieve both optimum illumination and, hence, high efficiency of the entire antenna arrangement, while at the same time the radiation pattern can be influenced. A specific result is that the necessary reflector area 6 may be significantly smaller compared to conventional beam scanning systems.

FIG. 6 shows a plan view of the dielectric support 9. It is secured to the mounting platform 3 using the spacers 11 which can be bolted. The dielectric support 9 includes a circular bore 12 at its center whose diameter corresponds to the dielectric field transformer 2. Around the bore 12 of the dielectric support 9, parasitic (passive) radiating elements with circuit components 10 are arranged. In FIG. 6, these have an exemplary uniform distribution in an angle of 90° each, where each element consists of a pair of radiators positioned orthogonally to each other. Further, on the dielectric support 9, a control block 13 including standard components is mounted, which controls the circuit components. The control block is connected to other downstream modules via a cable 14.

List of Reference Numbers

1 waveguide

2 dielectric field transformer

3 mounting platform

4 mount

5 triangle area

6 reflector

7 struts

8 downstream module

9 dielectric support plate

10 radiator components/circuit elements

11 spacers

12 bore

13 control block

14 cable

1. An arrangement for feeding a centrally focused antenna, characterized by
a waveguide (1),
a dielectric field transformer (2) mounted on said waveguide (1), and
a mounting platform (3) for downstream modules (8) mounted at an end of said waveguide (1).

2. The arrangement of claim 1, characterized in that said waveguide (1) includes a receiving means for said dielectric field transformer (2) and said dielectric field transformer (2) partly protrudes into said waveguide (1).

3. The arrangement of claim 1 or 2, characterized in that said dielectric field transformer (2) preferably comprises polytetrafluorethylene, polyethylene, polystyrene, polypropylene or a foamed plastic.

4. The arrangement of any of claims 1 to 3, characterized in that said dielectric field transformer (2) is connected to said waveguide (2) by press fit, adhesive bond, pinning or any combination thereof.

5. The arrangement of any of claims 1 to 4, characterized in that the geometry of said dielectric field transformer (2) is matched to the corresponding reflector system.

6. The arrangement of any of claims 1 to 5, characterized in that all components of said arrangement other than said dielectric field transformer (2) and said a dielectric support plate (9) are made of metal, preferably in one piece, wherein the interior of said waveguide (1) has a surface roughness of less than 0.5 μm.

7. The arrangement of any of claims 1 to 6, characterized in that said mounting platform (3) includes mounts (4) to which said a reflector (6) is mounted by means of struts (7), and said downstream module (8) is mounted in a rotatable and fixable manner about the axis of symmetry of said reflector (6).

8. The arrangement of any of claims 1 to 6, characterized in that dielectric support (9) is mounted in the vicinity of said dielectric field transformer (2) without being mechanically or electrically connected thereto, said dielectric support (9) including a circular bore (12) at the center thereof whose diameter corresponds to the diameter of said dielectric field transformer (2).

9. The arrangement of claim 8, characterized in that said dielectric support is preferably connected to said mounting platform (3) by means of bolted spacers (11) of metal or dielectric type, and is arranged in a plane-parallel manner thereto.

10. The arrangement of claim 8 or 9, characterized in that parasitic (passive) radiator elements, preferably feedable by radiation coupling, with circuit components (10) are arranged around said bore (12) individually or in orthogonally aligned pairs having a planar or three-dimensional geometry.

11. The arrangement of any of claims 8 to 10, characterized in that a control block (13) for driving said radiator elements with circuit components (10) is mounted on said dielectric support (9) and is supplied with digital signals outside the spectral frequency range of the antenna arrangement via a control cable (14).
